(19) United States
(12) Patent Application Publication
(10) Pub. No.: US 2026/0321885 A1
(43) Pub. Date: Oct. 15, 2026

(54) V4C3TX MXENE @ OPC COMPOSITE COATING AND SYNTHESIS METHOD THEREOF

(71) Applicants: NANJING UNIVERSITY, Nanjing City (CN); HAIAN INSTITUTE OF HIGH-TECH RESEARCH, NJU, Nantong City (CN)

(72) Inventors: Shaochun Tang, Nanjing City (CN); Qi Liang, Nanjing City (CN)

(73) Assignees: NANJING UNIVERSITY, Nanjing City (CN); HAIAN INSTITUTE OF HIGH-TECH RESEARCH, NJU, Nantong City (CN)

(21) Appl. No.: 19/543,625

(22) Filed: Feb. 18, 2026

(30) Foreign Application Priority Data
Apr. 10, 2025 (CN) 202510448193.5

(51) Int. Cl. H01M 50/434; C01B 32/342; C01B 32/372; C08K 9/02; C09D 7/40; C09D 7/62; H01M 50/443; H01M 50/489

(52) U.S. Cl. CPC H01M 50/434; C01B 32/342; C01B 32/372; C09D 7/40; C09D 7/62; H01M 50/443; H01M 50/489; C01P 2004/03; C01P 2004/80; C08K 9/02

(57) ABSTRACT

Provided are a V₄C₃T_{X} MXene @ OPC composite coating and a synthesis method thereof. The synthesis method includes: first, preparing a V₄C₃T_{X} nano-powder by wet chemically etching V₄AlC₃ MAX phase using HCl and LiF, then forming a metal-organic framework (MOF) by coordination of Zr⁴⁺ with H₂ATA, conducting a hydrothermal reaction to produce a Zr-MOF precursor, subjecting the Zr-MOF precursor to carbonization at 800 °C (high-temperature carbonization) under an argon atmosphere to convert the MOF into a porous carbon skeleton OPC (octahedral nanoporous carbon), and removing ZrO₂ by subsequent acid washing; and mixing the V₄C₃T_{X} MXene, OPC, and a PVDF (polyvinylidene fluoride) binder in a mass ratio of 7:2:1, and adding an NMP (N-methyl-2-pyrrolidone) solvent dropwise thereto, and grinding to form a uniform coating having a viscosity of 2000 cP to 3000 cP.

### CROSS REFERENCE TO RELATED APPLICATION

This patent application claims the benefit and priority of Chinese Patent Application No. 202510448193.5 filed with the China National Intellectual Property Administration on Apr. 10, 2025, the disclosure of which is incorporated by reference herein in its entirety as part of the present application.

### TECHNICAL FIELD

The present disclosure relates to the technical field of coating material preparation, and in particular to a V₄C₃T_{X} MXene @ OPC composite coating and a synthesis method thereof.

### BACKGROUND

Research on functional modification of lithium-sulfur battery separators is currently focusing on tackling three core challenges: suppression of polysulfide shuttle effect, synergistic failure of catalytic interfaces and conductive frameworks, and trade-off between kinetic performance and structural stability. The primary research efforts are manifested in the following aspects:

(1) Although traditional carbon-based coatings can provide a conductive network of 120 S/cm, physical adsorption energy for long-chain polysulfides is only 0.4 eV to 0.6 eV. Furthermore, coating delamination caused by volume expansion during cycling leads to a 380% surge in interfacial contact resistance after 500 cycles. Recent MXene-based modification strategies (such as Ti₃C₂T_{X}/CNTs hybrid coatings) have increased the adsorption energy to 1.2 eV through Lewis acid-base interactions with surface terminal groups. However, stacking of MXene sheet layers results in significant anisotropy in ion transport. Under high sulfur loading of 5mg/cm 2 , lithium-ion diffusion coefficient drops sharply to 2.3×10¹⁰ cm²/s, causing a concentration polarization overpotential as high as 270 mV.

(2) Synergistic failure mechanism between catalytic interfaces and conductive frameworks also represents a major technical barrier in the functional modification of lithium-sulfur battery separators. Although metal-organic framework-derived carbon materials possess a 3.2 nm mesoporous structure that enhances polysulfide confinement, heterogeneous interface with MXene exhibits a lattice mismatch of approximately 1.8%. The lattice mismatch leads to microcrack formation under charge-discharge stress, reducing exposure rate of catalytic active sites from an initial 82% to 31% after 300 cycles.

(3) The conflict between kinetic performance and structural stability is another major technical barrier in the functional modification of lithium-sulfur battery separators. The state-of-the-art MoS₂@rGO catalytic layer can achieve a specific capacity of 832 mAh/g at 0.5 C. However, two-dimensional planar structure causes vertical Li₂S deposition to exceed 50 nm in thickness, inducing localized stress concentration that propagates coating cracks at a rate of 1.2 μm per cycle. Emerging liquid metal modification strategies reduce Li₂S nucleation overpotential to 80 m V via adaptive interfaces. Nevertheless, under high current density (3 C), electromigration of metal droplets leads to uneven active material distribution, causing capacity retention rate to plummet to 41% after 100 cycles. Such multidimensional performance conflicts result in fundamental bottlenecks for industrial application of modified separators. When sulfur areal loading is increased to 8 mg/cm² , the volumetric energy density of the battery struggles to exceed 700 Wh/L, and cycle life at 1 C generally remains below 400 cycles, severely hindering practical application of high-energy-density lithium-sulfur batteries.

### SUMMARY

Embodiments of the present disclosure provide a V₄C₃T_{X} MXene @ OPC composite coating and a synthesis method thereof, which addresses the technical problems in the prior art such as suppression of polysulfide shuttle effect, synergistic failure of catalytic interfaces and conductive frameworks, and trade-off between kinetic performance and structural stability in functionalization-modified coatings for lithium-sulfur battery separators. Through synergistic effects of materials, electrocatalytic activity, conductivity, and polysulfide immobilization capability are significantly improved, thereby promoting uniform lithium-ion deposition.

Embodiments of the present disclosure provide a method for synthesizing a V₄C₃T_{X} MXene @ OPC (the V₄C₃T_{X} MXene @ OPC referring to an OPC coated with V₄C₃T_{X} MXene) composite coating, including the following steps:
step I: preparation of V₄C₃T_{X} nano flake-like powder
mixing a HCl solution and LiF to obtain a mixed solution, adding a V₄AlC₃ powder to the mixed solution and etching the V₄AlC₃ powder at 45 °C to 55 °C for 48 h to 72 h, to obtain a V₄C₃T_{X} suspension; and centrifuging the V₄C₃T_{X} suspension, and collecting a resulting precipitate, washing the resulting precipitate until neutral, and drying a resulting washed precipitate to obtain the V₄C₃T_{X} nano flake-like powder;
step II: preparation of octahedral nanoporous carbon (OPC)
(1) dissolving ZrCl₄ and H₂ATA in a mixed solution of DMF and acetic acid, subjecting a resulting mixed material to stirring and then sonicating until clear, and transferring the resulting mixture to a polytetrafluoroethylene tank and conducting a hydrothermal reaction; heating a resulting reaction product in an oven and then transferring to a centrifuge tube, repeatedly washing by using methanol until impurities are removed therefrom, and transferring a resulting washed material to a vacuum drying oven and drying; and grinding resulting dried particles into a powder;
(2) placing the powder in a tube furnace at 800 °C, carbonizing the powder for 150 min under a gas atmosphere, with a heating rate being a constant linear heating rate, to obtain a black powdered product; and
(3) adding the black powdered product to a 30 wt % hydrofluoric acid, stirring a resulting mixed substance to a reaction while stirring at room temperature for 8 h; after the reaction, centrifuging a resulting black powder by using deionized water until a supernatant becomes neutral; and transferring a resulting centrifugation product to a vacuum drying oven and heating at 80 °C to obtain the octahedral nanoporous carbon (OPC); and
step III: synthesis of V₄C₃T_{X} MXene @ OPC composite coating
mixing a V₄C₃T_{X} MXene obtained in step I, the OPC obtained in step II, and a binder in a ratio of 7:2:1, thoroughly grinding a resulting mixture for 30 min, adding an N-methylpyrrolidone (NMP) solution dropwise thereto and continuing grinding to obtain a coating, i.e., the V₄C₃T_{X} MXene @ OPC composite coating.

In some embodiments, in the V₄C₃T_{X} MXene, where T represents surface functional groups, primarily —OH, —O, or —F; and X represents the number of surface functional groups, which is unspecified and serves only as an identifier for the presence of surface functionalization.

In some embodiments, MXene refers to two-dimensional transition metal carbides/nitrides obtained by chemical etching of a MAX phase; and the MAX phase is a ternary carbide or nitride with a hexagonal layered crystal structure, where: M represents a transition metal (such as titanium Ti, vanadium V, chromium Cr, niobium Nb, etc.), A represents an element from groups 13 or 14 (primarily aluminum Al, but may also be silicon Si, gallium Ga, etc.), and X represents carbon or nitrogen.

In some embodiments, V₄C₃T_{X} MXene refers to a functionalized two-dimensional layered vanadium carbide.

In some embodiments, in step I, a concentration of the HCl solution is 12 mol/L, and a mass ratio of the HCl, the LiF, and the V₄AlC₃ powder is in a range of 5.48-10.95:1:0.625-1.25.

In some embodiments, in step II, the stirring and the sonicating are independently conducted for 15 min.

In some embodiments, in step II, the gas atmosphere is argon, and the heating rate is 5°C min⁻¹.

In some embodiments, in step III, the coating has a viscosity of 2000 cP to 3000 cP.

Embodiments of the present disclosure further provide a V₄C₃T_{X} MXene @ OPC composite coating prepared by the method as described above.

Embodiments of the present disclosure further provide use of a V₄C₃T_{X} MXene @ OPC composite coating, the V₄C₃T_{X} MXene @ OPC composite coating being applied as a functional coating onto a separator for lithium batteries, with a thickness of the V₄C₃T_{X} MXene @ OPC composite coating being 5 μm to 10 μm.

A technical solution provided in some embodiments of the present disclosure at least has the following technical effects:

1. MXene, OPC, and a PVDF (polyvinylidene fluoride) binder are mixed in a mass ratio of 7:2:1, where a high proportion of the MXene provides catalytic activity, the OPC enhances conductivity and adsorption capacity, and the PVDF ensures coating adhesion; and adding an NMP (N-methylpyrrolidone) solvent dropwise thereto, and a resulting mixture is then ground to obtain a uniform coating having a viscosity of 2000 cP to 3000 cP and excellent stickiness. The method effectively addresses the technical problems of suppression of polysulfide shuttle effect, synergistic failure of catalytic interfaces and conductive frameworks, and trade-off between kinetic performance and structural stability in functionalization-modified coatings for lithium-sulfur battery separators, and significantly improves electrocatalytic activity, conductivity, and polysulfide immobilization capability through synergistic effects of materials, thereby promoting uniform lithium-ion deposition, and simultaneously offering both mechanical stability and potential for industrial production.

2. When the V₄C₃T_{X} MXene @ OPC composite coating in some embodiments of the present disclosure is applied onto a battery separator, and the battery separator is used in a battery; the test results demonstrate that compared with uncoated separator, coated separator exhibits a significantly enhanced capability to redox kinetics of lithium polysulfide, and can reduce initial overpotential of Li₂S nucleation, thereby promoting rapid nucleation and growth kinetics of Li₂S.

### BRIEF DESCRIPTION OF THE DRAWINGS

FIG. 1A shows a scanning electron microscopy (SEM) image of the V₄C₃T_{X} MXene material prepared in Example 1 of the present disclosure, and FIG. 1B shows an SEM image of the OPC material prepared in Example 1 of the present disclosure;

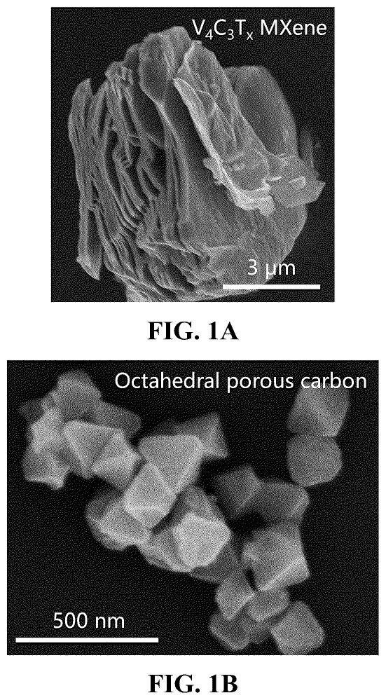

FIG. 2 shows bending and folding test pictures of the V₄C₃T_{X} MXene @ OPC-PP separator prepared in Example 2 of the present disclosure;

FIG. 3 shows cyclic voltammetry curves for three different types of separators prepared in Example 3 of the present disclosure, tested in a Li₂S₆-containing electrolyte;

FIG. 4 shows Li₂S nucleation test results of three different types of separators prepared in Example 3 of the present disclosure; and

FIG. 5 shows a graph of the rate cycling performance of three different types of separators prepared in Example 3 of the present disclosure.

### DETAILED DESCRIPTION OF THE EMBODIMENTS

Embodiments of the present disclosure provide a V₄C₃T_{X} MXene @ OPC composite coating and a synthesis method thereof, which addresses the technical problems in the prior art, such as suppression of polysulfide shuttle effect, synergistic failure of catalytic interfaces and conductive frameworks, and trade-off between kinetic performance and structural stability in functionalization-modified coatings for lithium-sulfur battery separators. Through synergistic effects of materials, the electrocatalytic activity, conductivity, and polysulfide immobilization capability are significantly improved, thereby promoting uniform lithium-ion deposition.

The technical solutions in some embodiments of the present disclosure address the above problems, and the overall concept is as follows:

First, preparing a V₄C₃T_{X} nano-powder by wet chemically etching V₄AlC₃ MAX phase, then forming a metal-organic framework (MOF) by coordination of Zr⁴⁺ with H₂ATA (aminotrimethylene phosphonic acid), followed by reacting at 120 °C for 48 hours to produce a Zr-MOF precursor, then subjecting the Zr-MOF precursor to carbonization at 800 °C (high-temperature carbonization) under an argon atmosphere to convert the MOF into a porous carbon skeleton OPC, and removing ZrO₂ by subsequent acid washing; and mixing MXene, OPC, and a PVDF binder in a mass ratio of 7:2:1, where a high proportion of the MXene provides catalytic activity, the OPC enhances conductivity and adsorption capacity, and PVDF ensures coating adhesion; and adding an NMP solvent dropwise thereto, followed by grinding to form a uniform coating having a viscosity of 2000 cP to 3000 cP, which can be uniformly applied onto a battery separator. The V₄C₃T_{X} MXene @ OPC composite coating-modified battery separator is used in a battery, and the test comparison results show the strongest current response at 0.41 V (oxidation peak) and −0.37 V (reduction peak), demonstrating a significantly accelerated LiPS conversion; a Li₂S deposition capacity of 277.78 mAh/g, which is better than the control groups (164.61 mAh/gand 145.42 mAh/g); and a capacity retention at 433.47 mAh/g at a high rate of 5 C, recovered to 1039.46 mAh/g at 0.2 C, demonstrating that the V₄C₃T_{X} MXene @ OPC composite coating-modified battery separator has excellent kinetic performance. Test results demonstrate that through synergistic effects of materials, the V₄C₃T_{X} MXene @ OPC composite coating significantly improves electrocatalytic activity, conductivity, and polysulfide immobilization capability, thus promoting uniform lithium-ion deposition and simultaneously offering both mechanical stability and potential for industrial production.

For a better understanding of the technical solutions described above, the technical solutions as described above will be described in detail below with reference to the accompanying drawings of the specification and specific examples.

### Example 1

Step I: preparation of V₄C₃T_{X} nano flake-like powder

(1) 20 mL to 40 mL of a HCl solution with a concentration of 12 M (mol/L) and 1.6 g of LiF were mixed to obtain a mixed solution, and 1 g to 2 g of a V₄AlC₃ powder was added to the mixed solution, and the V₄AlC₃ powder was etched at 45 °C to 55 °C for 48 h to 72 h to obtain a V₄C₃T_{X} suspension.

(2) The V₄C₃T_{X} suspension was centrifuged, a resulting precipitate was collected, washed to neutral, and dried in sequence to obtain the V₄C₃T_{X} nano flake-like powder (V4C₃Tx MXene).

Step II: preparation of octahedral nanoporous carbon (OPC) (1) 0.396 g of ZrCl 4 and 0.306 g of H 2ATA were dissolved in a mixed solution of 45 mL of DMF and 5 mL of acetic acid, a resulting mixture was stirred for 15 min, and then sonicated for 15 min. A resulting clear solution was transferred to a 100 mL polytetrafluoroethylene tank and subjected to a hydrothermal reaction. After heating at 120 °C in an oven for 48 h, a resulting product was transferred to a centrifuge tube and repeatedly washed by using methanol 6 times. A resulting washed product was transferred to a vacuum drying oven and heated at 90 °C for 3 h, and resulting dried particles were ground into a powder.

(2) 0.3 g of the powder was placed in a tube furnace at 800 °C and subjected to carbonization for 150 min, where a carbonization atmosphere was argon, and a heating rate was 5 °C min⁻¹. A black powdered product was obtained.

(3) 0.4 g of the black powdered product was added to 30 mL of hydrogen fluoride (30 wt %). A resulting mixture was subjected to a reaction while stirring at room temperature for 8 h. After the reaction, a resulting black powder was centrifuged by using deionized water until a supernatant was neutral. A resulting centrifugation product was transferred to a vacuum drying oven and heated at 80 °C for 12 h to obtain the octahedral nanoporous carbon (OPC).

Step III: synthesis of V₄C₃T_{X} MXene @ OPC composite coating The V₄C₃T_{X} MXene prepared in step I, the OPC produced in step II, and a binder PVDF were mixed in a ratio of 7:2:1, a resulting mixture was thoroughly grounded for 30 min, and an N-methylpyrrolidone (NMP) solution was added thereto dropwise, and a resulting mixture was grounded continuously to obtain a uniform coating, i.e., the V₄C₃T_{X} MXene @ OPC composite coating.

### Example 2

The V₄C₃T_{X} MXene @ OPC composite coating was applied onto a commercial PP (polypropylene) separator and then dried in a vacuum oven at 60 °C for 12 h, obtaining a modified V₄C₃T_{X} MXene @ OPC-PP separator.

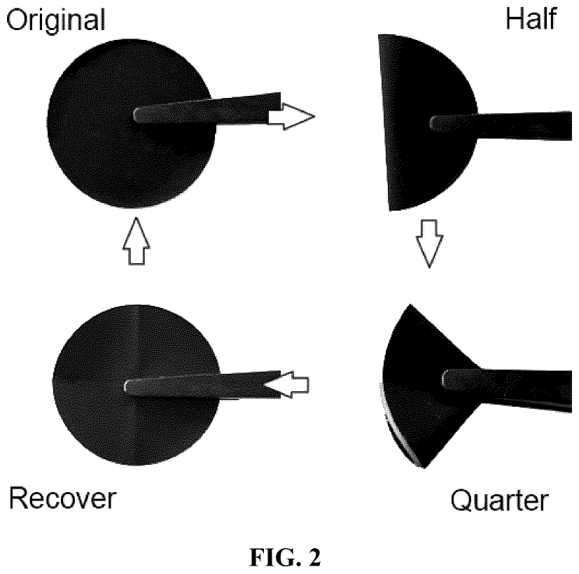

Referring to FIG. 2, the V₄C₃T_{X} MXene @ OPC coating exhibits strong adhesion to the commercial separator, with no obvious powder detachment observed even after repeated folding, indicating the excellent adhesive properties of the V₄C₃T_{X} MXene @ OPC composite coating.

### Example 3

The V₄C₃T_{X} MXene @ OPC-PP separator obtained in Example 2 was assembled into a button cell in the order of sulfur/porous carbon positive electrode→electrolyte→separator→electrolyte→lithium metal negative electrode. During assembly, 25 μL of electrolyte was added dropwise to each side of the positive and negative electrodes. A resulting assembled cell was then left to stand for 24 h, followed by corresponding electrochemical testing.

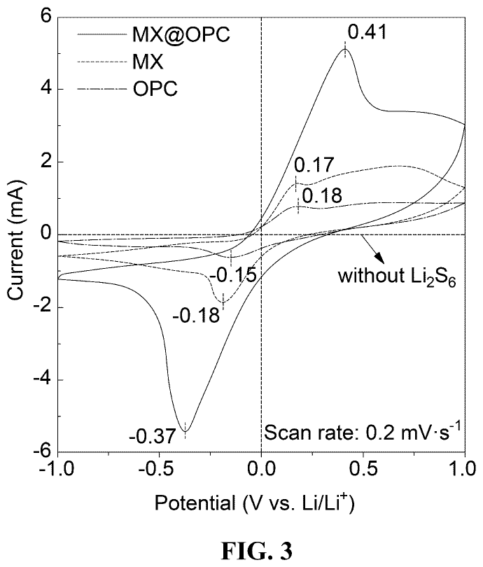

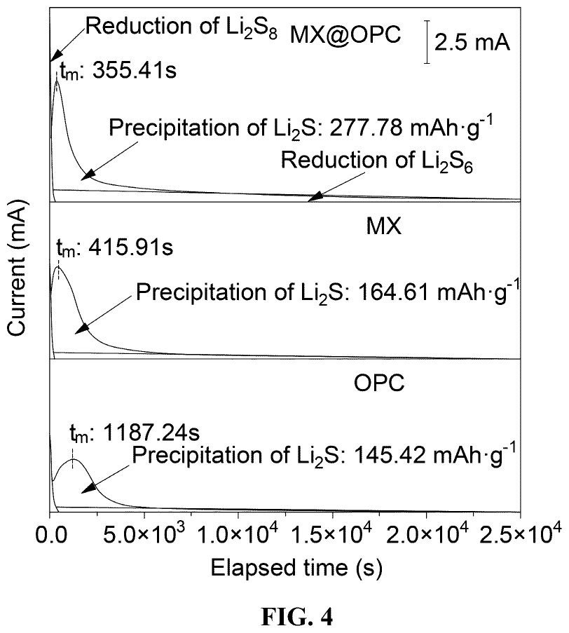

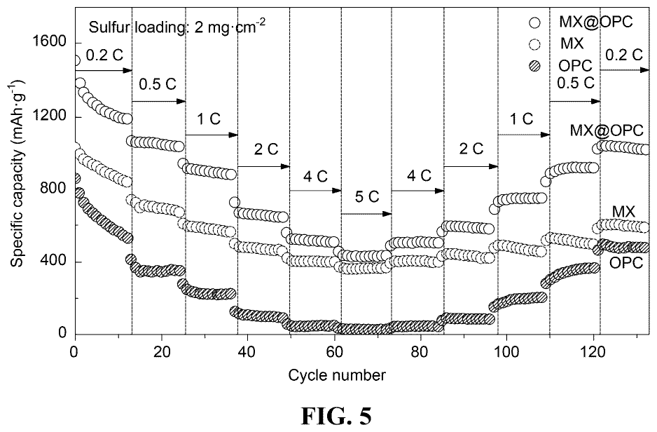

Referring to FIGS. 3 to 5, in the cyclic voltammetry curves test in FIG. 3, an electrolyte containing Li₂S₆ was used. In the Li₂S nucleation test in FIG. 4, an electrolyte containing Li₂S₈ was used on the cathode side, while a conventional electrolyte was used on the anode side. In the rate cycling performance graph in FIG. 5, a conventional electrolyte was used.

The test results are shown in FIG. 3, during the polarization process, Li₂S₆ was converted into higher-order and lower-order polysulfides at the anode and cathode, respectively. Among different types of separators, the battery based on the V₄C₃T_{X} MXene @ OPC-PP separator demonstrates the largest peak areas and the highest peak current responses (0.41 V and −0.37 V), indicating a strongly enhanced capability in promoting the kinetics of the lithium polysulfide redox reaction.

Referring to FIG. 4, the results of the potentiostatic nucleation experiments in FIG. 4 reveal that the solid-state Li₂S deposition is regulated differently by various separators. According to Faraday's law, the specific capacities of Li₂S deposited on the cathode are calculated in FIG. 4 as 277.78 mAh g⁻¹, 164.61 mAh g⁻¹, and 145.42 mAh g⁻¹ for the three separators, respectively. The results suggest that the V₄C₃T_{X} MXene @ OPC-PP separator reduces the initial overpotential for Li₂S nucleation, thereby promoting rapid nucleation and enhanced growth kinetics of Li₂S.

Referring to FIG. 5, at a current density of 5 C, the specific capacity is maintained at 433.47 mAh g⁻¹. When the current density is reset to 0.2 C, the discharge capacity is restored to 1039.46 mAh g⁻¹. The excellent rate performance of the optimized battery confirms the enhanced kinetic capacity of lithium polysulfide conversion, which is attributed to the synergistic enhancement effect of V₄C₃T_{X} MXene and porous carbon OPC.

The technical solutions as described above in some embodiments of the present disclosure at least have the following technical effects:

1. By mixing MXene, OPC, and a PVDF binder in a mass ratio of 7:2:1, where a high proportion of the MXene provides catalytic activity, the OPC enhances conductivity and adsorption capacity, and the PVDF ensures coating adhesion; and adding an NMP solvent dropwise thereto, followed by grinding to form a uniform coating having a viscosity of 2000 cP to 3000 cP and excellent stickiness, the method effectively addresses technical problems of suppression of polysulfide shuttle effect, synergistic failure of catalytic interfaces and conductive frameworks, and trade-off between kinetic performance and structural stability in functionalization-modified coatings for lithium-sulfur battery separators, and significantly improves electrocatalytic activity, conductivity, and polysulfide immobilization capability through synergistic effects of materials, thereby promoting uniform lithium-ion deposition, and simultaneously offering both mechanical stability and potential for industrial production.

2. When a V₄C₃T_{X} MXene @ OPC composite coating in some embodiments of the present disclosure is applied onto a battery separator, the test results demonstrate that compared with uncoated separator, coated separator exhibits a significantly enhanced capability to redox kinetics of lithium polysulfide, and can reduce initial overpotential of Li₂S nucleation, thereby promoting rapid nucleation and growth kinetics of Li₂S.

Although preferred embodiments of the present disclosure have been described, those skilled in the art may make additional changes and modifications to these embodiments once they become aware of the basic inventive concept. Therefore, the appended claims are intended to be construed as including the preferred embodiments and all alterations and modifications falling within the scope of the present disclosure.

It will be clear that those skilled in the art may make various modifications and variations of the present disclosure without departing from the spirit and scope of the present disclosure. In this way, the present disclosure is intended to encompass such modifications and variations that fall within the scope of the claims and equivalents thereof.

1. A method for synthesizing a composite coating comprising an octahedral nanoporous carbon coated with V₄C₃T_{X} MXene, comprising the following steps:
a first step comprising mixing a HCl solution and LIF to obtain a mixed solution, adding a V₄AlC₃ (vanadium aluminum carbide) powder to the mixed solution and etching the V₄AlC₃ powder at 45 °C to 55 °C for 48 hours to 72 hours, to obtain a V₄C₃T_{X} suspension; and centrifuging the V₄C₃T_{X} suspension, and collecting a resulting precipitate, washing the resulting precipitate until neutral, and drying a resulting washed precipitate to obtain a V₄C₃T_{X} nano flake-like powder;
a second step comprising dissolving ZrCl₄ (zirconium tetrachloride) and H₂ATA (aminotrimethylene phosphonic acid) in a mixed solution of DMF (N,N-dimethylformamide) and acetic acid, subjecting a resulting mixed material to stirring and then sonicating until clear, and transferring the resulting mixed material to a polytetrafluoroethylene tank and conducting a hydrothermal reaction; heating a resulting reaction product in an oven and then transferring to a centrifuge tube, repeatedly washing by using methanol until impurities are removed therefrom, and transferring a resulting washed material to a first vacuum drying oven and drying; and grinding resulting dried particles into a powder;
placing the powder in a tube furnace at 800 °C, carbonizing the powder for 150 min under a gas atmosphere, with a heating rate being a constant linear heating rate, to obtain a black powdered product; and
adding the black powdered product to a 30 wt % hydrofluoric acid, subjecting a resulting mixed substance to a reaction while stirring at room temperature for 8 hours; after the reaction, centrifuging a resulting black powder by using deionized water until a supernatant becomes neutral; and transferring a resulting centrifugation product to a second vacuum drying oven and heating at 80 °C to obtain the OPC; and
a third step comprising mixing the V₄C₃T_{X} nano flake-like powder obtained in the first step, the OPC obtained in the second step, and a binder in a mass ratio of 7:2:1, grinding a resulting mixture for 30 minutes, and adding an N-methylpyrrolidone solution dropwise thereto and continuing grinding to obtain a coating.

2. The method of claim 1, wherein in the first step, a concentration of the HCl solution is 12 mol/L, and a mass ratio of the HCl solution, the LiF, and the V₄AlC₃ powder is in a range of 5.48-10.95:1:0.625-1.25.

3. The method of claim 1, wherein in the second step, the stirring and the sonicating are independently conducted for 15 minutes.

4. The method of claim 1, wherein in the second step, the gas atmosphere is argon, and the heating rate is 5 °C min^{-1.}

5. The method of claim 1, wherein in step the third step, the coating has a viscosity of 2000 cP (centipoise) to 3000 cP.

6. A V₄C₃T_{X} MXene @ OPC composite coating prepared by the method of claim 1.

7. The coating of claim 6, wherein coating is applied as a functional coating onto a separator for lithium batteries, with a thickness of the coating being 5 μm to 10 μm.

8. The coating of claim 6, wherein in the first step, a concentration of the HCl solution is 12 mol/L, and a mass ratio of the HCl solution, the LiF, and the V₄AlC₃ powder is in a range of 5.48-10.95:1:0.625-1.25.

9. The coating of claim 6, wherein in step the second step, the stirring and the sonicating are independently conducted for 15 minutes.

10. The coating of claim 6, wherein in the second step, the gas atmosphere is argon, and the heating rate is 5°C min⁻¹.
